(19) United States
(12) Patent Application Publication
(10) Pub. No.: US 2009/0103943 A1
(43) Pub. Date: Apr. 23, 2009

(54) DEVELOPER, DEVELOPING DEVICE, IMAGE FORMING APPARATUS, PROCESS CARTRIDGE, AND IMAGE FORMING METHOD

(76) Inventor: Koichi SAKATA, Shizuoka-ken (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/252,693

(22) Filed: Oct. 16, 2008

(30) Foreign Application Priority Data
Oct. 17, 2007 (JP) 2007-270571

(51) Int. Cl. G03G 21/18; G03G 9/107; G03G 15/08

(52) U.S. Cl. 399/111; 430/111.4; 399/258

(57) ABSTRACT

A two-component developer used in an image forming apparatus including a latent image bearing member and a developing device includes a magnetic carrier and a toner. The toner includes a toner base and inorganic fine particles as an external additive. A loose apparent density of the toner is not greater than 0.39 g/cm³. A coverage of the external additive over the toner base of the toner is not greater than 80% of a surface area of the toner base. An apparent density of the developer is in a range of from 1.55 g/cm³ to 1.70 g/cm³. The developing device includes a developer bearing member, a supply transport path, a circulation transport path, and a partition member.

### CROSS-REFERENCE TO RELATED APPLICATIONS

The present patent application claims priority pursuant to 35 U.S.C. §119 from Japanese Patent Application No. 2007-270571, filed on Oct. 17, 2007 in the Japan Patent Office, the entire contents of which are hereby incorporated herein by reference.

### BACKGROUND OF THE INVENTION

1. Field of the Invention

The present invention relates to a developer containing at least a toner and a carrier to develop a latent image borne on a latent image bearing member such as a photoconductor, and a developing device, a process cartridge, an image forming apparatus, and an image forming method using the developer.

2. Description of the Background

Image forming apparatuses are used as copiers, printers, facsimile machines, and multi-functional devices combining several of the foregoing capabilities. A conventional image forming apparatus includes a developing device using a two-component developer including toner and magnetic carrier.

A conventional developing device using a two-component developer has a configuration like that illustrated in FIG. 1, which shows an end-on axial view thereof. In FIG. 1, the developing device 104 includes two developer transport paths, i.e., a supply collection transport path 402 and an agitation transport path 10. The supply collection transport path 402 includes a supply collection screw 401, and the agitation transport path 10 includes an agitation screw 11. The supply collection transport path 402 serves as a supply transport path for transporting and supplying developer to a developing roller 5, and is partitioned from the agitation transport path 10 by a partition member 133. The partition member 133 has openings that connect the supply collection transport path 402 and the agitation transport path 10 at end portions in an axial direction of the developing roller 5. The direction in which the developer is transported in the supply collection transport path 402 is opposite to the direction in which the developer is transported in the agitation transport path 10, allowing the developer to be circulated within the developing device 104. The agitation transport path 10 functions as a circulation transport path for transporting the developer, which has reached a downstream end portion in the transport direction of the supply collection transport path 402, to an upstream end portion of the transport direction of the supply collection transport path 402.

In a developing device like the developing device 104, the developer in the supply collection transport path 402 is supplied to the surface of the developing roller 5, and is used for development at a development area, i.e., an area at which the developing roller 5 faces a photoconductor. After passing the development area, the developer on the developing roller 5 is collected to the supply collection transport path 402. That is, the transport path for supplying developer to the developing roller 5 and the transport path for collecting the developer on the developing roller 5 after the developer passes through the development area are combined in the developing device 104. Consequently, as the developer approaches the downstream end portion of the transport direction of the supply collection transport path 402, the concentration of toner in the developer may decrease, resulting in a reduction in the density of an image during development processing.

Such a decrease in density may be prevented by providing a developing device with a supply transport member for supplying developer to a developing roller and a collection transport member for collecting the developer having passed through a development area, as in the following examples of such conventional developing devices shown in FIG. 2 and FIG. 3.

FIG. 2 is one example of such conventional developing devices.

The conventional developing device 204 separately includes a supply transport path 9 for supplying developer to the developing roller 5 and a collection transport path 7 for collecting the developer having passed through a development area. As illustrated in FIG. 2, a partition member 133 separates the supply transport path 9 and the collection transport path 7, each of which faces the developing roller 5. The supply transport path 9 is located above the collection transport path 7 and behind the partition member 133. The partition member 133 has openings that connect the supply transport path 9 and the collection transport path 7 at end portions in the axial direction of the developing roller 5. The transport direction of developer is transported in the supply transport path 9 is opposite to the transport direction of developer in the collection transport path 7, allowing a portion of the developer to be circulated. The collection transport path 7 functions as a circulation transport path for transporting the developer, which has been collected from the developing roller 5, and the developer, which has reached a downstream end portion in the transport direction of the supply transport path 9, to an upstream end portion of the transport direction of the supply transport path 9.

In the developing device 204, the developer having passed through the development area is transported to the collection transport path 7, thereby preventing the developer from getting into the supply transport path 9. Accordingly, fluctuations in the concentration of toner in the developer in the supply transport path 9 may be prevented, allowing the concentration of toner to be maintained substantially constant in the developer supplied to the developing roller 5.

FIG. 3 is another example of the above-described conventional developing device.

The developing device 304 separately includes a supply transport path 9 for supplying developer to the developing roller 5 and a collection transport path 7 for collecting the developer. The developing device 304 further includes an agitation transport path 10 that, while agitating the developer transported to a downstream end portion of the supply transport path 9 and the collected developer transported to a downstream end portion of the collection transport path 7, transports the agitated developer in a direction opposite to the transport direction of the supply transport path 9. As illustrated in FIG. 3, the supply transport path 9 is located above the supply transport path 9 and behind a partition member 133. The partition member 133 has openings that connect the supply transport path 9 and the agitation transport path 10 at end portions in the axial direction of the developing roller 5. The transport direction of the developer in the supply transport path 9 is opposite to the transport direction of the developer in the agitation transport path 10, allowing the developer to be circulated. The agitation transport path 10 functions as a circulation transport path for transporting the developer, which has been collected to the collection transport path 7 and has reached the downstream end portion of the transport direction of the collection transport path 7, and the developer, which has reached the downstream end portion in the transport direction of the supply transport path 9, to the upstream end portion of the transport direction of the supply transport path 9.

In the developing device 304, the developer having passed through a development area is transported to the collection transport path 7, thereby preventing the developer from getting into the collection transport path 7. As a result, fluctuations in the concentration of toner in the developer may be prevented, allowing the concentration of toner to be maintained substantially constant in the developer supplied to the developing device 304.

However, in the above-described conventional developing devices 204 and 304 illustrated in FIGS. 2 and 3, toner may be scattered from the devices and the scattered toner may adhere to a photoconductor or a recording medium, resulting in background fogging. The inventor of this disclosure believes that such background fogging is caused as follows.

The conventional developing devices 204 and 304 need to transport the developer upward when transferring the developer from the developer transport path, which functions as the circulation transport path, to the supply transport path 9. Accordingly, the conventional developing device 204 or 304 pushes the developer toward the downstream end portion of the circulation transport path by using a transfer screw for providing a force against the developer in the circulation transport path, thereby transporting the developer upward to the supply transport path 9. With such a configuration, as the bulk of the developer having reached the downstream end portion of the circulation transport path increases, the developer may clog the opening of the partition member 133 through which the developer is transferred from the downstream end portion of the circulation transport path to the supply transport path 9. Consequently, such clogging may prevent air flow in the developing device, resulting in an increase in internal pressure of the circulation transport path.

Meanwhile, the developer may be degraded due to the mechanical stress of repeated agitation over time, resulting in a reduction in fluidity and an increase in the bulk of the developer. Such increase in the bulk of the developer may also result in an increase in internal pressure of the circulation transport path, causing toner to leak from a gap between the developing device and the developing roller 5 or a supply port of toner and resulting in toner scattering from the device.

Recent market trends demand further increases in the speed of image formation of image forming apparatuses of all sorts. However, such increase in the image formation speed may more readily reduce the concentration of toner in the developer, resulting in failures such as uneven concentration due to sufficient dispersion of toner or background fogging due to insufficiently charged toner. The capacity of developer in the developing device may be increased so as to raise the tolerance for a reduction in the concentration of toner. However, since such increase in the capacity of developer in the developing device may increase fluctuations in the bulk of the developer and degradation in the developer over time may also increase the bulk of the developer, thereby more readily resulting in failures such as toner scattering from the device due to an increase in the internal pressure of the circulation transport path.

In view of the above-described situation, the present invention provides a developer used in a developing device including a supply transport path above a circulation transport path to prevent background fogging from appearing due to toner scattering over time, and the developing device, an image forming apparatus, a process cartridge, and an image forming method using the developer.

### SUMMARY OF THE INVENTION

At least one of illustrative embodiments of the present invention provides a toner supply device capable of reliably opening and closing a shutter member to prevent toner from being scattered, and an image forming apparatus including the toner supply device.

In one illustrative embodiment of the present invention, a two-component developer used in an image forming apparatus including a latent image bearing member and a developing device includes a magnetic carrier and a toner. The toner includes a toner base and inorganic fine particles as an external additive. A loose apparent density of the toner is not greater than 0.39 g/cm³. A coverage of the external additive over the toner base of the toner is not greater than 80% of a surface area of the toner base. An apparent density of the developer is in a range of from 1.55 g/cm³ to 1.70 g/cm³. The developing device includes a developer bearing member, a supply transport path, a circulation transport path, and a partition member. The developer bearing member rotates while bearing the developer and supplies the toner to a latent image on the latent image bearing member at an area at which the developer bearing member faces the latent image bearing member. The supply transport path includes a supply transport member to transport the developer in a transport direction along an axial direction of the developer bearing member and supply the developer to the developer bearing member. The circulation transport path includes a circulation transport member to transport the developer, transported to a downstream end portion in the transport direction of the supply transport path, to an upstream end portion in the transport direction of the supply transport path. The supply transport path is disposed above the circulation transport path. The partition member partitions the supply transport path from the circulation transport path and includes openings that connect the supply transport path and the circulation transport path at end portions in the axial direction of the developer bearing member.

In another illustrative embodiment of the present invention, a developing device used in an image forming apparatus including a latent image bearing member employs a two-component developer including a magnetic carrier and a toner. The toner includes a toner base and inorganic fine particles as an external additive. The developing device includes a developer bearing member, a supply transport path, a circulation transport path, and a partition member. The developer bearing member rotates while bearing the developer and supplies the toner to a latent image on the latent image bearing member at an area at which the developer bearing member faces the latent image bearing member. The supply transport path includes a supply transport member to transport the developer in a transport direction along an axial direction of the developer bearing member and supply the developer to the developer bearing member. The circulation transport path includes a circulation transport member to transport the developer, transported to a downstream end portion in the transport direction of the supply transport path, to an upstream end portion in the transport direction of the supply transport path. The supply transport path is disposed above the circulation transport path. The partition member partitions the supply transport path from the circulation transport path and includes openings that connect the supply transport path and the circulation transport path at end portions in the axial direction of the developer bearing member. A loose apparent density of the toner is not greater than 0.39 g/cm³. A coverage of the external additive over the toner base of the toner is not greater than 80% of a surface area of the toner base. An apparent density of the developer is in a range of from 1.55 g/cm³ to 1.70 g/cm³.

In still another illustrative embodiment of the present invention, an image forming apparatus includes a latent image bearing member, a charging unit, a latent image forming unit, and a developing device. The latent image bearing member bears a latent image. The charging unit charges the latent image bearing member. The latent image forming unit forms the latent image on the latent image bearing member. The developing device develops the latent image into a toner image using a two-component developer including a magnetic carrier and a toner. The toner includes a toner base and inorganic fine particles as an external additive. The developing device includes a developer bearing member, a supply transport path, a circulation transport path, and a partition member. The developer bearing member rotates while bearing the developer and supplies the toner to the latent image on the latent image bearing member at an area at which the developer bearing member faces the latent image bearing member. The supply transport path includes a supply transport member to transport the developer in a transport direction along an axial direction of the developer bearing member and supply the developer to the developer bearing member. The circulation transport path includes a circulation transport member to transport the developer, transported to a downstream end portion in the transport direction of the supply transport path, to an upstream end portion in the transport direction of the supply transport path. The supply transport path is disposed above the circulation transport path. The partition member partitions the supply transport path from the circulation transport path and includes openings that connect the supply transport path and the circulation transport path at end portions in the axial direction of the developer bearing member. A loose apparent density of the toner is not greater than 0.39 g/cm³. A coverage of the external additive over the toner base of the toner is not greater than 80% of a surface area of the toner base. An apparent density of the developer is in a range of from 1.55 g/cm³ to 1.70 g/cm³.

### BRIEF DESCRIPTION OF THE DRAWINGS

A more complete appreciation of the disclosure and many of the attendant advantages thereof will be readily acquired as the same becomes better understood by reference to the following detailed description when considered in connection with the accompanying drawings, wherein:

FIG. 1 is a schematic configuration view illustrating a conventional developing device;

FIG. 2 is a schematic configuration view illustrating a conventional developing device;

FIG. 3 is a schematic configuration view illustrating a conventional developing device;

FIG. 4 is a schematic configuration view illustrating an image forming apparatus according to an illustrative embodiment of the present invention;

FIG. 5 is a schematic configuration view illustrating a developing device and a photoconductor;

FIG. 6 is a perspective sectional view illustrating flow of developer in the developing device;

FIG. 7 is a schematic view illustrating flow of developer in the developing device;

FIG. 8 is a sectional view illustrating the developing device;

FIG. 9 is a schematic view illustrating flow of developer in a developing device according to a comparative example; and

FIG. 10 is an external perspective view illustrating a developing device according to an illustrative embodiment of the present invention.

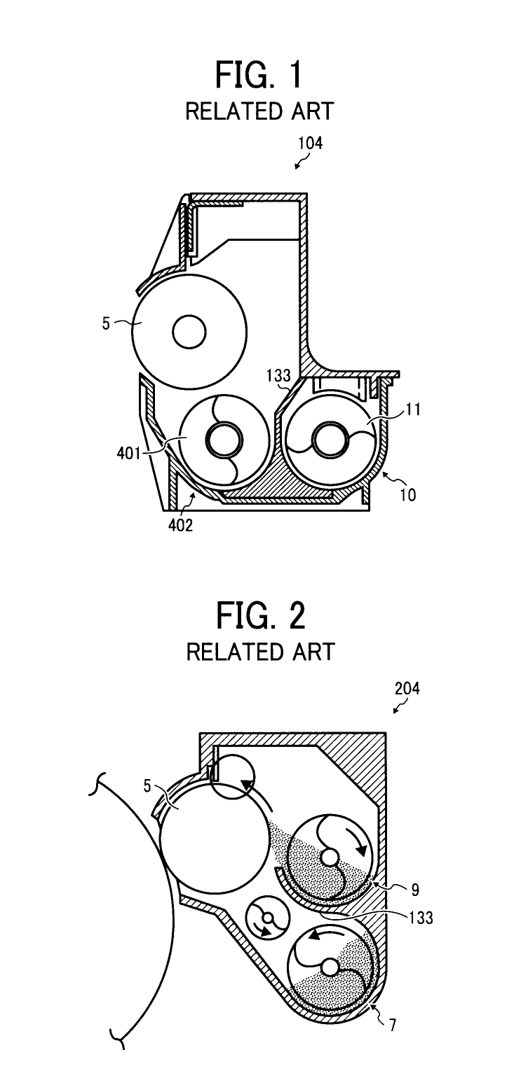

The accompanying drawings are intended to depict illustrative embodiments of the present disclosure and should not be interpreted to limit the scope thereof. The accompanying drawings are not to be considered as drawn to scale unless explicitly noted.

### DETAILED DESCRIPTION OF ILLUSTRATIVE EMBODIMENTS

In describing illustrative embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Below, taking as an example a tandem-type color laser copier (hereinafter a “copier”) in which a plurality of photoconductors are arranged side by side, an image forming apparatus 500 according to an illustrative embodiment of the present invention is described.

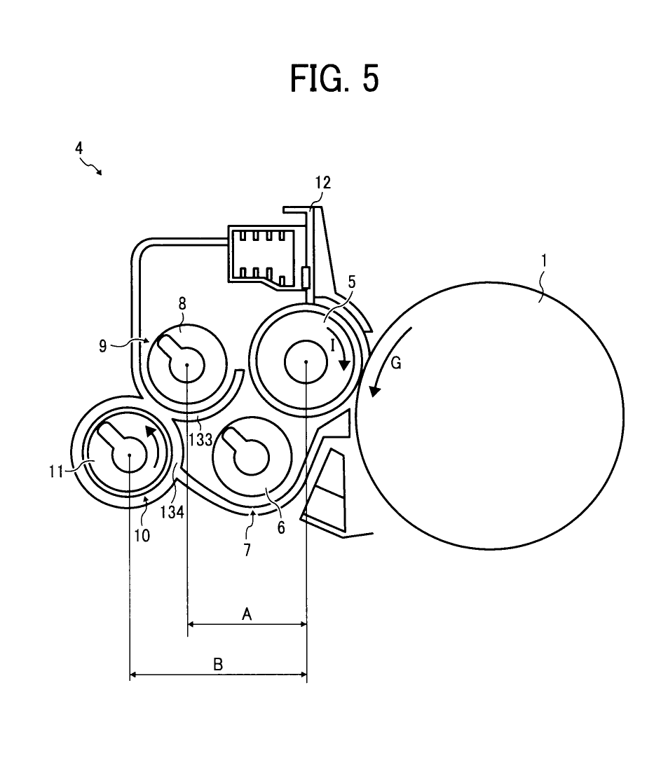

FIG. 5 is a schematic view illustrating a configuration of the image forming apparatus 500 according to this illustrative embodiment. As illustrated in FIG. 5, the image forming apparatus 500 includes, for example, a printer section 100, a sheet feed device 200 on which the printer section 100 is mounted, and a scanner 300 disposed on the printer section 100, and an automatic document feeder 400 disposed on the scanner 300.

The printer section 100 includes an image forming unit 20 formed with, for example, four process cartridges 18Y, 18M, 18C, and 18K to form images of yellow (Y), magenta (M), cyan (C), and black (K), respectively. Hereinafter, the letters Y, M, C, and K added to numeral codes indicate components or members for yellow, magenta, cyan, and black, respectively. In addition to the process cartridges 18Y, 18M, 18C, and 18K, the image forming apparatus 500 further includes, for example, an optical write unit 21, an intermediate transfer unit 17, a secondary transfer device 22, a pair of registration rollers 49, and a fixing device 25 using a belt fixing system.

The optical write unit 21 includes, for example, a light source, a polygon mirror, an f-θ lens, and a reflection mirror, and emits a laser beam onto the surface of each photoconductor based on scanned image data.

Each of the process cartridges 18Y, 18M, 18C, and 18K includes, for example, a drum-shaped photoconductor 1, a charger, a developing device 4, a drum cleaner, and a discharger.

Below, taking the process cartridge 18Y for yellow as an example, the process cartridges 18Y, 18M, 18C, and 18K are described further in detail.

The charger serving as a charging unit uniformly charges the surface of the photoconductor 1Y. The charged surface of the photoconductor 1Y is irradiated with a laser beam modulated and deflected by the optical write unit 21 according to the scanned image data. As a result, the electric potential of a portion irradiated or exposed with the laser beam decreases, so that an electrostatic latent image for yellow is formed on the surface of the photoconductor 1Y. The electrostatic latent image for yellow is developed with the developing device 4Y into a yellow toner image.

The yellow toner image formed on the photoconductor 1Y is primarily transferred onto an intermediate transfer belt 110. After the primary transfer process, the drum cleaner removes residual toner remaining on the surface of the photoconductor 1Y.

After the cleaning process, the discharger discharges the photoconductor 1Y. Then, the charger uniformly charges the surface of the photoconductor 1Y again, and thus the photoconductor 1Y is initialized. Likewise, a series of processes similar to those described above is performed at each of the other process cartridges 18M, 18C, and 18K.

Next, the intermediate transfer unit 17 is described.

The intermediate transfer unit 17 includes, for example, the intermediate transfer belt 110, a belt cleaner 90, a tension roller 14, a driving roller 15, a secondary transfer back-up roller 16, and primary transfer bias rollers 62Y, 62M, 62C, and 62K.

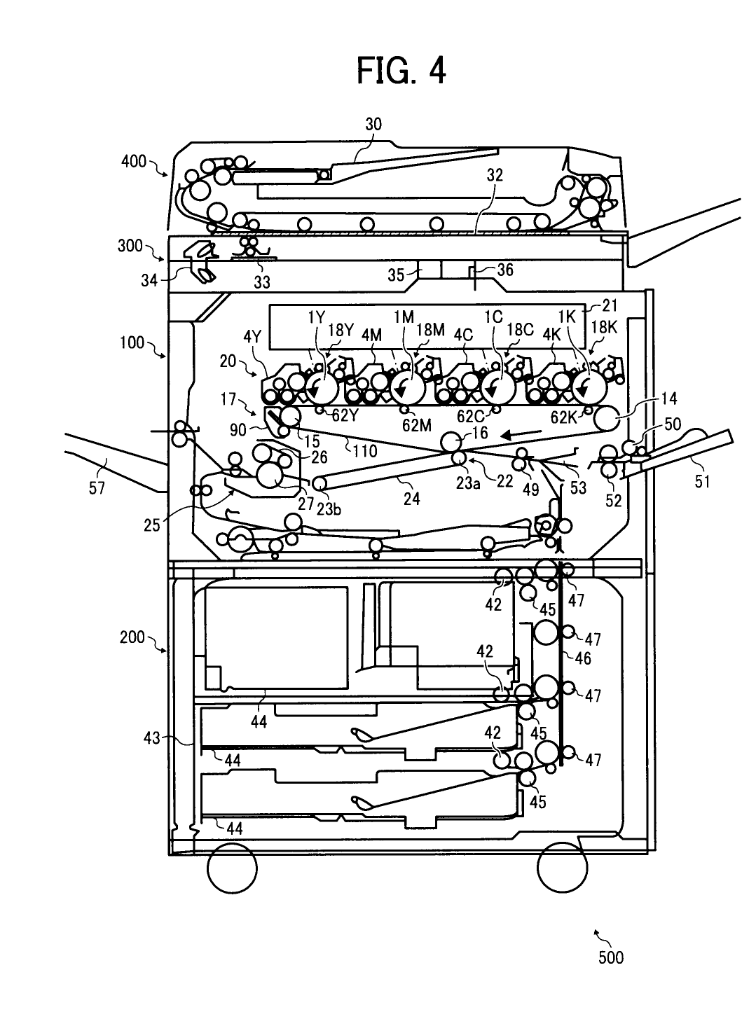

The intermediate transfer belt 110 is stretched between a plurality of rollers including the tension roller 14. As the driving roller 15 is rotated by a belt driving motor, the intermediate transfer belt 110 is endlessly moved in a clockwise direction in FIG. 4.

The four primary-transfer bias rollers 62Y, 62M, 62C, and 62K are disposed so as to contact an inner circumferential surface of the intermediate transfer belt 110 and receive primary-transfer biases supplied from a power supply. The primary-transfer bias rollers 62Y, 62M, 62C, and 62K press the intermediate transfer belt 110 from the inner circumferential surface toward the photoconductors 1Y, 1M, 1C, and 1K, respectively, to form primary-transfer nips. At each primary-transfer nip, the primary-transfer bias forms primary-transfer electric fields between each photoconductor and the corresponding primary-transfer bias roller.

The above-described yellow toner image formed on the photoconductor 1Y is primarily transferred onto the intermediate transfer belt 110 by the primary-transfer electric field and nip pressure at the primary transfer nip. Magenta, cyan, and black toner images on the photoconductors 1M, 1C, and 1K are primarily transferred onto the yellow toner image so as to be sequentially superimposed one on another. Thus, a four-color composite toner image (hereinafter a “four-color toner image”) including the multiple toner images is formed on the intermediate transfer belt 110.

The four-color toner image superimposingly transferred on the intermediate transfer belt 110 is secondarily transferred onto a transfer sheet, serving as a recording material, at a secondary transfer nip. After passing through the secondary transfer nip, the belt cleaner 90 sandwiching the intermediate transfer belt 110 between it and the driving roller 15 removes residual toner remaining on the surface of the intermediate transfer belt 110.

Next, the secondary transfer device 22 is described.

In FIG. 4, the secondary transfer device 22 is disposed below the intermediate transfer unit 17. In the secondary transfer device 22, a sheet conveyance belt 24 is extended between two tension rollers 23a and 23b. As at least one roller of the tension rollers 23a and 23b is driven, the sheet conveyance belt 24 is endlessly moved in a counterclockwise direction in FIG. 4. The tension roller 23a sandwiches the intermediate transfer belt 110 and the sheet conveyance belt 24 between it and the secondary-transfer back-up roller 16 of the intermediate transfer unit 17. Such sandwiching forms the secondary transfer nip at which the intermediate transfer belt 110 of the intermediate transfer unit 17 contacts the sheet conveyance belt 24 of the secondary transfer device 22. A secondary transfer bias having a polarity opposite to the polarity of the toner is supplied to the tension rollers 23a from a power supply. Such supply of the secondary transfer bias forms secondary-transfer electric fields to electrostatically move the four-color toner image on the intermediate transfer belt 110 toward the tension roller 23a. The pair of registration rollers 49 feeds the transfer sheet so as to synchronize with the four-color toner image on the intermediate transfer belt 110. The four-color toner image is secondarily transferred onto the transfer sheet by the secondary-transfer electrical field and nip pressure at the secondary transfer nip.

Alternatively, instead of the above-described secondary transfer system to supply the secondary transfer bias to the tension roller 23a, a charger may be provided to charge the transfer sheet in a non-contact manner, for example.

The sheet feed device 200 disposed at a lower portion of the image forming apparatus 500 includes a plurality of vertically stacked sheet feed cassettes 44. Each sheet feed cassette 44 is capable of storing a plurality of transfer sheets stacked in a bundled state and pressing a sheet feed roller 42 against a topmost sheet of the bundled transfer sheets. As the sheet feed roller 42 is rotated, the topmost transfer sheet is fed toward a sheet feed path 46.

The sheet feed path 46 receiving the transfer sheet fed from the sheet feed cassette 44 is provided with a plurality of pairs of conveyance rollers 47 and a pair of registration rollers 49 disposed near an end portion of the sheet feed path 46. The transfer sheet conveyed to the pair of registration rollers 49 is sandwiched between the pair of registration rollers 49. Meanwhile, in the intermediate transfer unit 17, the four-color toner image formed on the intermediate transfer belt 110 is conveyed into the secondary transfer nip as the intermediate transfer belt 110 is endlessly moved. The pair of registration rollers 49 feeds the transfer sheet sandwiched therebetween at such a timing that the transfer sheet closely contacts the four-color toner image at the secondary transfer nip. By closely contacting the four-color toner image with the transfer sheet at the secondary transfer nip, the four-color toner image is secondarily transferred onto the transfer sheet, so that a full-color image is formed on the transfer sheet of white color, for example. As the sheet conveyance belt 24 is endlessly moved, the transfer sheet having the full-color image passes through the secondary transfer nip and is fed from the sheet conveyance belt 24 to the fixing device 25.

The fixing device 25 includes a belt unit and a pressure roller 27. The belt unit includes a fixing belt 26 and two, first and second, rollers. The fixing belt 26 is extended between the first and second rollers so as to be endlessly movable. The pressure roller 27 is pressed against the first roller. The fixing belt 26 and the pressure roller 27 contact each other to form a fixing nip at which the transfer sheet received from the sheet conveyance belt 24 is sandwiched. The first roller pressed by the pressure roller 27 includes a heat source for heating the fixing belt 26. The fixing belt 26 heated by the first roller heats the transfer sheet sandwiched at the fixing nip. Such heat and pressure at the fixing nip fixes the full-color image on the transfer sheet.

After the fixing process in the fixing device 25, the transfer sheet is stacked on a stack portion 57 projectingly provided from a left-side plate of an apparatus housing in FIG. 4, or is returned to the secondary transfer nip to form a toner image on another face of the transfer sheet.

When copying a bundle of documents, the bundle of documents may be set on a document table 30 of the automatic document feeder 400. Alternatively, if one side of the documents is bound in a book form, the documents are set on a contact glass 32. Before setting the documents, the automatic document feeder 400 is opened relative to a body of the image forming apparatus 500 so as to expose the contact glass 32 of the scanner 12 to the outside. Then, the automatic document feeder 400 is closed to press the one-side bound documents against the contact glass 32.

After setting the documents, a copy start button is pressed to start a document reading operation of the scanner 12. Alternatively, if the bundle of documents is set on the automatic document feeder 400, the automatic document feeder 400 automatically feeds the sheet documents one by one to the contact glass 32 before the document reading operation.

In the document reading operation, a first carriage 33 and a second carriage 34 start running, and a light source of the first carriage 33 emits light. The light is reflected on the surface of the document and a mirror of the second carriage 34, passes through a focus lens 35, and enters into a reading sensor 36. The reading sensor 36 creates image data based on the entered light.

In parallel with the document reading operation, devices in the process cartridges 18Y, 18M, 18C, and 18K, the intermediate transfer unit 17, the secondary transfer device 22, and the fixing device 25 start driving. The driving of the optical write unit 21 is controlled based on the image data created by the reading sensor 36 so as to form yellow, magenta, cyan, and black toner images on the photoconductors 40Y, 40M, 40C, and 40K, respectively. The toner images are superimposed on the intermediate transfer belt 110 so that a full-color toner image is formed on the intermediate transfer belt 110.

At substantially the same time as the start of the document reading operation, the sheet feed device 200 starts a sheet feed operation. In the sheet feed operation, as one of the sheet feed rollers is selected to rotate, a transfer sheet is fed from a corresponding one of the sheet feed cassettes 44 stacked in a paper bank 43. The transfer sheet fed from the corresponding sheet feed cassette 44 is separated one by one with a corresponding separation roller 45, moved into the sheet-feed path 46, and conveyed toward the secondary transfer nip with the pair(s) of conveyance rollers 47.

Instead of the sheet feeding from the sheet feed cassette 44, transfer sheets may be fed from a manual feed tray 51. In such case, as a manual feed roller 50 is selected and rotated to feed the transfer sheets from the manual feed tray 51, a separation roller 52 separates and feeds the transfer sheets one by one to a manual feed path 53 of the printer section 10.

When forming a multiple-color image of more than two color toners, the image forming apparatus 500 holds an upper extending face of the intermediate transfer belt 110 substantially horizontal so that the upper extending surface contacts the photoconductors 1Y, 1M, 1C, and 1K. Alternatively, when forming a black-and-white image of only black toner, a tilting mechanism tilts the intermediate transfer belt 110 down to the left in FIG. 4 so as to separate the upper extending face from the photoconductors 1Y, 1M, and 1C. Only the photoconductor 1K among the four photoconductors is rotated in the counterclockwise direction in FIG. 4 to form a black toner image. At this time, the developing devices 4Y, 4M, and 4C as well as the photoconductors 1Y, 1M, and 1C may be stopped, thereby preventing them from being unnecessarily wasted.

The image forming apparatus 500 further includes a control unit and an operation display unit. The control unit also includes, for example, a CPU (central processing unit) to control devices and components in the image forming apparatus 500. The operation display unit includes, for example, a liquid crystal display and various key buttons. An operator performs key input operations through the operation display unit to send commands to the control unit. In such operations, the operator is allowed to select one of, for example, three modes as a simplex print mode for forming an image on only one side of a transfer sheet. The three simplex print modes are, for example, direct ejection mode, reverse ejection mode, and reverse decurling ejection mode.

FIG. 5 is an enlarged view illustrating a configuration of the developing device 4 and the photoconductor 1 provided in one of the process cartridges 18Y, 18M, 18C, and 18K. The process cartridges 18Y, 18M, 18C, and 18K have substantially identical configurations except for differences in toner color, and therefore the subscripts Y, M, C, and K are omitted from the developing device 4Y, 4M, 4C, and 4K in FIG. 5 for simplicity.

As illustrated in FIG. 5, as the photoconductor 1 rotates in a direction indicated by an arrow G in FIG. 5, the surface of the photoconductor 1 is charged by the charger. The charged surface of the photoconductor 1 is irradiated with a laser beam from the optical write unit 21, so that an electrostatic latent image is formed on the surface of the photoconductor 1. The developing device 4 supplies toner to the electrostatic latent image to form a toner image.

The developing device 4 supplies the toner to the latent image on the surface of the photoconductor 1 while rotating the surface of the developing device 4 in a direction (hereinafter a “surface moving direction”) indicated by an arrow I in FIG. 5. The developing device 4 includes a developing roller 5 serving as a developer bearing member for development and a supply screw 8 serving as a developer supply transport member to transport developer toward the back side of FIG. 5 along an axial direction of the developing roller 5 while supplying the developer to the developing roller 5. The supply screw 8 also includes a spiral-shaped blade portion disposed parallel to the axial direction of the developing roller 5.

The developing device 4 includes a developing doctor 12 on a downstream side in the surface moving direction I from an area in which the developing roller 5 faces the supply screw 8. The developing doctor 12 serves as a developer regulation member to regulate the developer supplied to the developing roller 5 into a thickness suitable for development.

The developing device 4 further includes a correction screw 6 at a downstream side portion in the surface moving direction I from a development area in which the developing roller 5 faces the photoconductor 1. The correction screw 6 serves as a collection transport member to collect the used developer having passed through the development area and transport the collected developer in the same direction as the developer transport direction of the supply screw 8. A supply transport path 9 including the supply screw 8 is disposed alongside the developing roller 5. A collection transport path 7 including the collection screw 6 is disposed below the developing roller 5.

The developing device 4 further includes an agitation transport path 10 below the supply transport path 9 and alongside the collection transport path 7. The agitation transport path 10 includes an agitation screw 11 serving as an agitation transport member to transport developer in a direction opposite to the developer transport direction of the supply screw 8, i.e., toward a front side of FIG. 5 while agitating the developer along the axial direction of the developing roller 5. The agitation screw 11 includes a spiral-shaped blade portion disposed parallel to the axial direction of the developing roller 5.

The supply transport path 9 and the agitation transport path 10 are partitioned by a partition member 133. The partition member 133 includes a partition area that partitions the supply transport path 9 and the agitation transport path 10, and openings at end portions of the partition area on the front and back sides of FIG. 5. The supply transport path 9 and the agitation transport path 10 connect each other through the openings.

As illustrated in FIG. 5, the supply transport path 9 is disposed above the partition member 133 behind the agitation transport path 10.

Although the supply transport path 9 and the collection transport path 7 are partitioned by the partition member 133, no openings are provided at a partition area that partitions the supply transport path 9 and the collection transport path 7.

The agitation transport path 10 and the collection transport path 7 are partitioned by a partition wall 134 serving as a second partition member. The partition wall 134 has an opening at the front side thereof in FIG. 5, and the agitation transport path 10 and the collection transport path 7 connects each other through the opening.

Each of the supply screw 8, the collection screw 6, and the agitation screw 11 serving as the developer transport member is of resin and has a screw diameter of 18 mm, a screw pitch of 25 mm, and a rotation speed of approximately 600 rpm (revolutions per minutes).

The developer is formed into a thin layer on the developing roller 5 by the doctor blade 12 made of, for example, stainless and is transported to the development area, i.e., the area in which the developing roller 5 faces the photoconductor 1, to develop a latent image on the photoconductor 1. The developing roller 5 is, for example, an aluminum seamless tube having a diameter of 25 mm, and the surface of the developing roller 5 is subjected to V-shaped grooving or sandblasting. A gap between the surface of the developing roller 5 and each of the developing doctor 12 and the photoconductor 1 is set to 0.3 mm.

After the development process, the developer is collected in the collection transport path 7, transported to the front side of the collection transport path 7 in the section illustrated in FIG. 5, and transferred to the agitation transport path 10 through the opening of the partition wall 134, which is provided to a portion corresponding a non-image area (or outside an end portion of the development area in the axial direction of the developing roller 5). Toner is supplied to the agitation transport path 10 from a toner supply port provided above the agitation transport path 10 near the opening of the partition wall 134 at an upstream side in the developer transport direction of the agitation transport path 10.

Next, a description is given of circulation of developer in the above-described three developer conveyance paths.

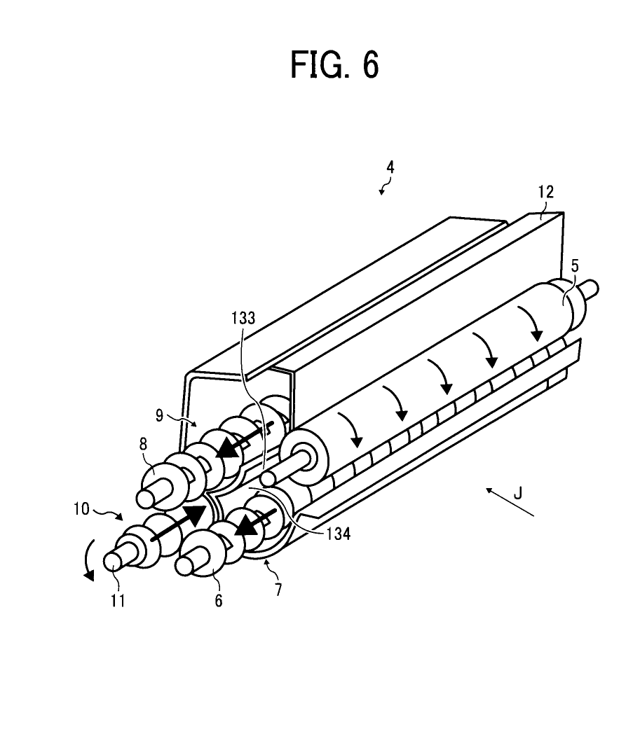

FIG. 6 is a perspective section view of the developing device 4 illustrating the flow of developer in the developer conveyance paths. Each arrow in FIG. 6 indicates a moving direction of the developer.

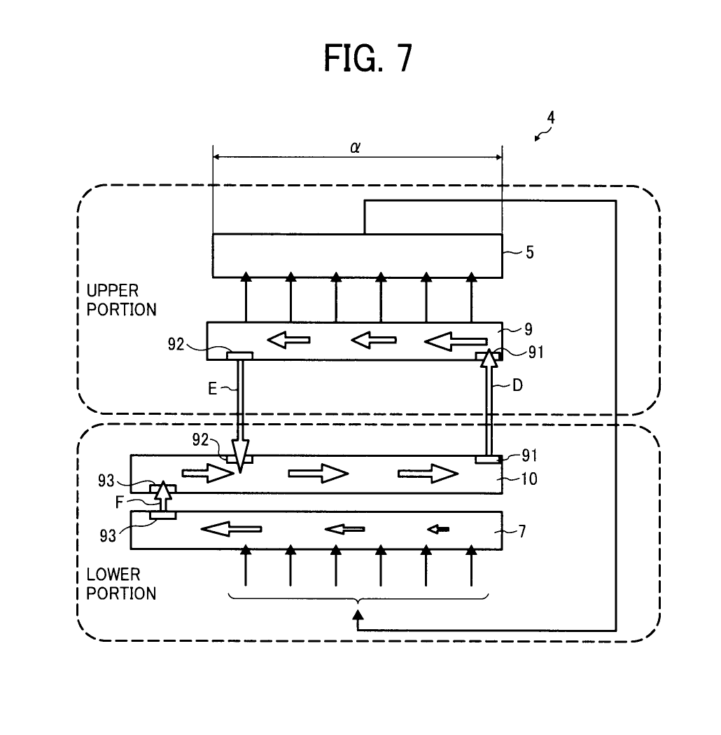

FIG. 7 is a schematic view illustrating the flow of developer in the developing device 4. Likewise, each arrow in FIG. 7 indicates a moving direction of the developer.

When receiving the developer supplied from the agitation transport path 10, the supply transport path 9 transports the developer to the downstream side in the developer transport direction of the supply screw 8 while supplying the developer to the developing roller 5. A portion of the developer supplied to the developing roller 5 is not used for development and transported to the downstream end portion in the developer transport direction of the supply transport path 9. As indicated by an arrow E in FIG. 7, such excess developer is supplied to the agitation transport path 10 from an opening 92 provided at a front-side portion of the partition member 133 in FIG. 5 or 6.

Another portion of the developer is transported from the developing roller 5 to the collection transport path 7 and transported to a downstream end portion in the developer transport direction of the collection transport path 7 by the collection screw 6. As indicated by an arrow F in FIG. 7, such collected developer is supplied to the agitation transport path 10 through an opening 93, which is the opening of the partition wall 134.

The agitation transport path 10, while agitating the excess developer and the collected developer into agitated developer, transports the agitated developer to an upstream side in the developer transport direction of the supply screw 8. The agitated developer is transported by the agitation screw 11 to a downstream end portion of the developer transport direction of the agitation transport path 10. As indicated by an arrow D in FIG. 7, the agitated developer is supplied to the supply transport path 9 through an opening 91, which is the opening on the back side of the partition member 133 in FIG. 5 or 6.

In the agitation transport path 10, the agitation screw 11 agitates and transports the collected developer, the excess developer, and toner, which is supplied from a transfer portion as needed, in a direction opposite to the developer transport direction of the collection transport path 7 or the supply transport path 9. Thus, the agitation transport path 10 functions as a circulation transport path to transport the developer, which has reached the downstream end portion in the developer transport direction of the supply transport path 9, to the upstream end portion of the developer transport direction of the supply transport path 9. Further, below the agitation transport path 10 is provided a toner concentration sensor that operates a toner supply control device through sensor output to supply toner from a toner container.

The developing device 4 includes the supply transport path 9 and the collection transport path 7 to separately perform the supply of developer to the developing roller 5 and the collection of developer from the developing roller 5 using the different developer transfer paths, thereby preventing used developer from getting into the supply transport path 9. As a result, at a portion closer to the downstream end in the developer transfer direction of the supply transport path 9, a reduction in toner concentration of the developer supplied to the developing roller 5 can be prevented more effectively. Further, the developing device 4 includes the collection transport path 7 and the agitation transport path 10 to separately perform the collection and agitation of developer in the different developer transport path, thereby preventing used developer from dropping off during agitation. As a result, sufficiently-agitated developer can be supplied to the supply transport path 9, thereby preventing the developer from being supplied to the supply transport path 9 in a poorly-mixed state. Thus, the developing device 4 can prevent a reduction in toner concentration and lack of mixing of the developer in the supply transport path 9, thereby maintaining the density of an image under development substantially uniform.

As illustrated in FIG. 5, the agitation transport path 10 and the collection transport path 7 are located at substantially the same level in the developing device 4. Accordingly, when developer is transferred from the collection transport path 7 to the agitation transport path 10, the developer does not need to be moved upward, thereby suppressing stress against the developer. Further, the supply transport path 9 is located higher than the agitation transport path 10 and the collection transport path 7. Such configuration can save space with respect to a horizontal direction compared to a configuration in which the three developer transport paths are located at the same level.

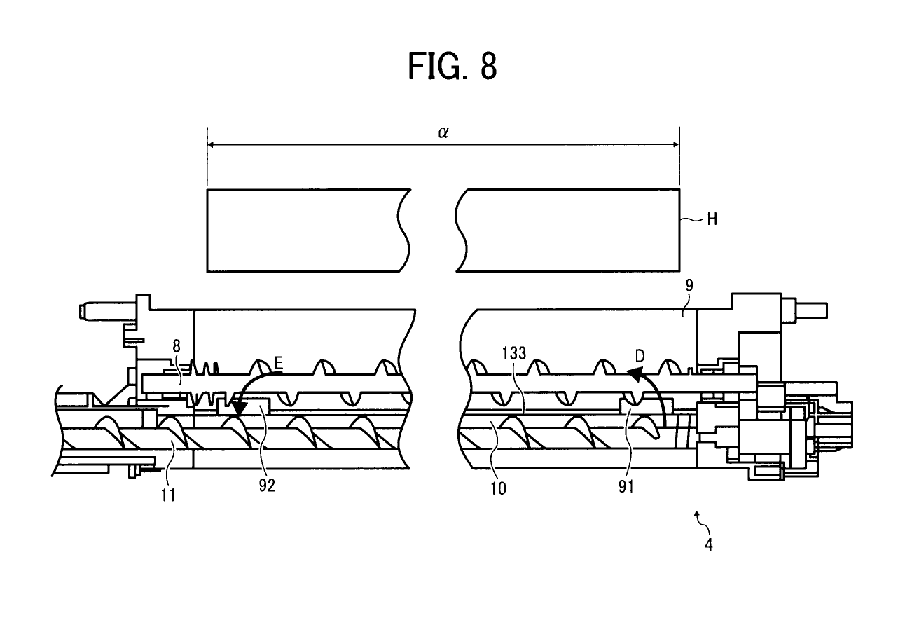

FIG. 8 is a sectional view illustrating a section passing through a rotation center of the supply screw 8 of the developing device 4 viewed from a direction indicated by an arrow J of FIG. 6. In FIG. 8, the development area H represents an area in which the developing roller 5 serving as the developer bearing member supplies toner onto the photoconductor 1 serving as the latent image bearing member, and a development area width α represents a width of the development area H in the axial direction of the rotation axis of the developing roller 5.

As illustrated in FIG. 8, the opening 91 of the partition member 133 connecting the upstream end portion in the developer transport direction of the supply transport path 9 and the downstream end portion in the developer transport direction of the agitation transport path 10 is located within the development area width α in the axial direction of the developing roller 5. In other words, the opening 91 is located between the end portions in the axial direction of the developing roller 5. Further, the opening 92 of the partition member 133 connecting the downstream end portion in the developer transport direction of the supply transport path 9 and the upstream end portion in the developer transport direction of the agitation transport path 10 is located within the development area width α in the axial direction of the developing roller 5. In other words, the opening 92 is located between the end portions in the axial direction of the developing roller 5.

In the developing device 4, both the opening 91 through which the developer is moved up from the agitation transport path 10 to the supply transport path 9, and the opening 92 through which the developer is moved down from the supply transport path 9 to the agitation transport path 10 is located within the development area width α in the axial direction of the developing roller 5.

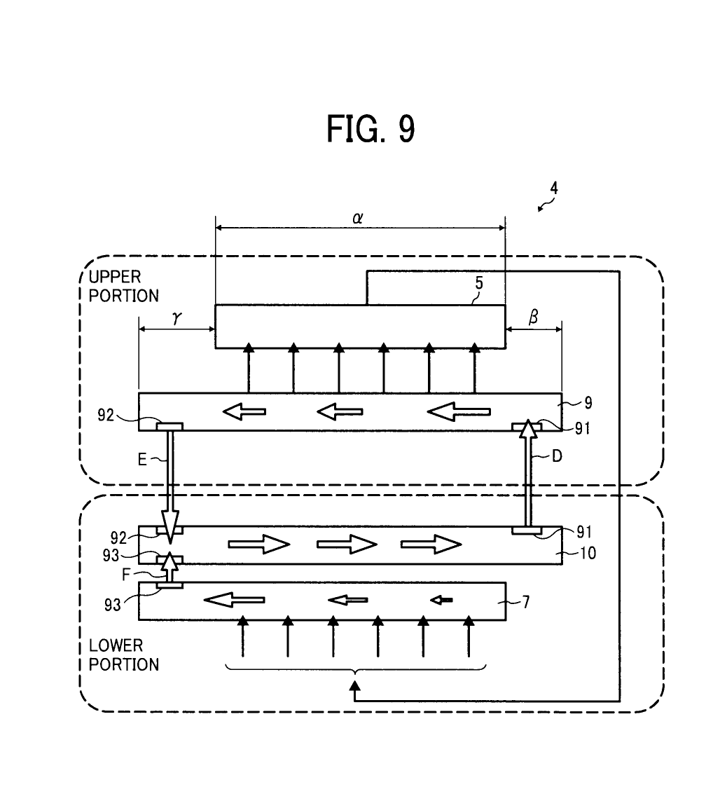

FIG. 9 is a schematic view illustrating a flow of developer in a developing device 4 according to a comparative example in which the opening 91 and the opening 92 are located outside the development area width α in the axial direction of the developing roller 5.

As illustrated in FIG. 9, since the opening 91 is located outside the development area width α in the axial direction of the developing roller 5, the upstream end portion in the developer transport direction of the supply transport path 9 is longer than the developing roller 5 by a length β of an upstream portion of the supply transport path 9. Further, since the opening 92 is located outside the development area width α in the axial direction of the developing roller 5, the downstream end portion of the supply transport path 9 is longer than the developing roller 5 by a length γ of a downstream portion of the supply transport path 9.

By contrast, in the developing device 4 of FIG. 7 according to this illustrative embodiment, the opening 91 is located within the development area width α in the axial direction of the developing roller 5, thereby allowing the upstream side in the developer transport direction of the supply transport path 9 to be set shorter than that of the developing device 4 of FIG. 9 by the length β of the upstream portion of the supply transport path 9. Further, the opening 92 is located within the development area width α in the axial direction of the developing roller 5, thereby allowing the downstream side in the developer transport direction of the supply transport path 9 to be set shorter than that of the developing device 4 of FIG. 9 by the length γ of the downstream portion of the supply transport path 9.

As described above, in the developing device 4 according to this illustrative embodiment, the opening 91 and the opening 92 are located within the development area width α, thereby allowing the developing device 4 to save space in an upper portion thereof compared to the developing device 4 of FIG. 9.

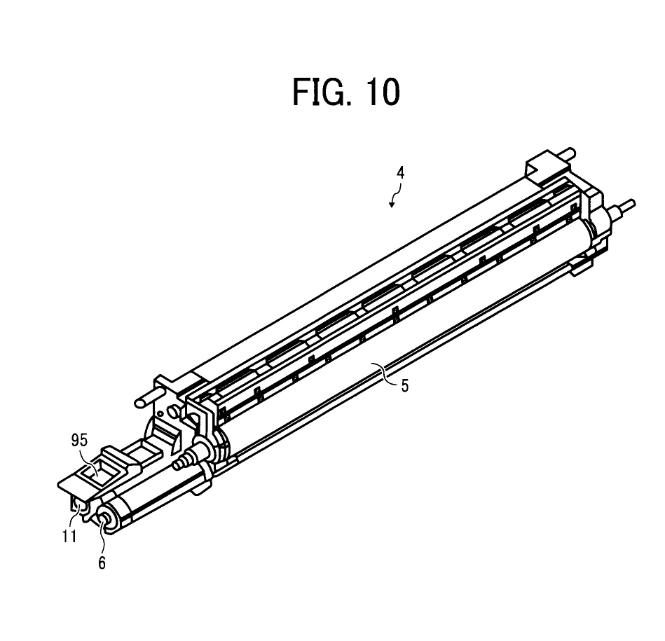

Next, a description is given of a portion at which developer is supplied to each of the developer transport paths of the developing device 4 including the supply transport path 9, the agitation transport path 10, and the collection transport path 7. FIG. 10 is a perspective view illustrating the developing device 4.

As illustrated in FIG. 10, a toner supply port 95 for supplying toner is provided above the upstream end portion in the developer transport direction of the agitation transport path 10 including the agitation screw 11. The toner supply port 95 is located outside an end portion in the width direction of the developing roller 5, i.e., outside the development area width α.

The toner supply port 95 is on an extension line in the developer transport direction of the supply transport path 9 and is positioned in a space corresponding to the downstream portion γ of the supply transport path 9 in FIG. 9. Thus, the toner supply port 95 is provided in the space obtained by locating the opening 92 within the development area width α, thereby allowing the developing device 4 to be downsized.

It is to be noted that the position of the toner supply port 95 is not limited to the above-described position above the upstream end portion in the developer transport direction of the agitation transport path 10 but may be, for example, above a downstream end portion of the collection transport path 7.

Alternatively, the toner supply port 95 may be provided above the opening 93 through which developer is transferred from the collection transport path 7 to the agitation transport path 10. Above the opening 93, there is a space obtained by locating the opening 92 within the development area width α. Accordingly, locating the toner supply port 95 at this space allows the developing device 4 to be downsized. Further, since the developer can be more readily mixed at the opening 93, supplying toner at the opening 93 allows the developer to be more effectively agitated.

As illustrated in FIG. 7, developer is moved upward from the lower portion to the upper portion of the developing device 4 only in the direction indicated by an arrow D. In the transfer of developer in the direction indicated by the arrow D, the developer is pushed and moved upward by rotation of the agitation screw 11 to be supplied to the supply transport path 9.

Such transfer of the developer may block an air flow in the developing device 4, thereby resulting in an increase in internal pressure of the developing device 4. In particular, a relatively great amount of developer flows into the agitation transport path 10 of FIG. 7, while such developer flows out from only the opening 91, i.e., a portion through which the developer needs to be moved upward. As a result, an increase in the bulk of the developer due to bulk fluctuations may result in a relatively high proportion of the volume of developer relative to the capacity of the transport path, thereby increasing the internal pressure. Consequently, toner may be scattered or blown from the supply port.

In the developing device 4, one side of the closed space in the agitation transport path 10 serves as a portion in which developer is moved upward, so that the side is substantially closed. Meanwhile, since the developer is transported into the agitation transport path 10 from the other side of the closed space, an air flow in the agitation transport path 10 cannot flow out from the agitation transport path 10. Consequently, inflow of the developer having an increased bulk may result in an increase in the internal pressure of the agitation transport path 10.

If the particle diameters of the toner and the carrier are relatively small or the total amount of the developer is relatively large, such increase in the internal pressure of the developing device 4 may also result in more notable toner scattering from the device.

To prevent such increase in the internal pressure of the developing device and toner scattering from the device due to an increase in the bulk of the developer, various improvements have been attempted.

For example, a conventional developing device has a storing portion for refilling or collecting developer so as to cope with fluctuations in the bulk of developer. Although such configuration can stably supply developer to a developing roller, the conventional developing device may not effectively prevent an increase in internal pressure of the device. Such storing portion needs to be provided to each developing device, resulting in upsizing of the device. Further, such storing portion may not achieve a sufficient performance if the particle diameters of a toner and a carrier are relatively small or the total amount of the developer is relatively large.

Another conventional developing device has two sensors for detecting magnetic permeability, including one sensor for detecting the bulk of developer, so as to prevent the developing performance of the developer from being reduced due to fluctuations in the bulk of the developer. Although such configuration can prevent such a reduction in the developing performance of the developer, the conventional developing device may not suppress an increase in the internal pressure of the device due to fluctuations in the bulk of the developer. Consequently, such configuration may not effectively prevent toner scattering from the device.

Still another conventional developing device employs, as an initial developer, a developer in which toner and carrier are mixed in advance for a certain time so that the bulk density thereof reaches a maximum value. With such configuration, toner scattering can be prevented from being caused by an increase in the bulk of developer due to degradation of the developer. However, if the developer remains unused for a long time, the bulk of the developer may decrease. In such case, a sufficient amount of the developer may not be supplied to the developing roller, resulting in image failure. Further, the above-described configuration may not prevent fluctuations in toner concentration. Consequently, the conventional developing device may not effectively prevent toner scattering if the particle diameters of a toner and a carrier are relatively small or the total amount of the developer is relatively large.

Alternatively, to prevent an increase in internal pressure, a conventional developing device may control air flow or use a filter. However, if the volume of the developer is relatively large, only using a filter is not enough to cope with such increase in the internal pressure. For example, in some of the above-described conventional developing devices or the developing device 4 according to this illustrative embodiment, it may be difficult to mount such filter at a lower portion thereof. Alternatively, controlling air flow may result in upsizing of the developing device. Further, one side of the transport path serves as the portion for moving the developer upward, making it difficult to pass an air flow through the transport path.

A conventional developing device is capable of ejecting an air flow through an air vent to prevent an increase in the internal pressure of the device, readily separating a filter that may need maintenance due to toner clogging and so on, and being downsized. Although such configuration is effective in the case in which developer transport sections are arranged side by side, in some of the above-described conventional developing device and the developing device 4 according to this illustrative embodiment, the developer may occupy most of the volume of the developer transport path, making it difficult to form an air vent at the developer transport path.

Next, a description is given of a distinctive feature of the present invention.

As the case with the developing device 4 according to this illustrative embodiment, a developing device having a structure to move developer upward from a lower portion to an upper portion may suffer from an increase in internal pressure due to fluctuations in the bulk of the developer and, as a result, toner scattering from the device. Meanwhile, suppressing the fluidity of toner, reducing the amount of free external additive over time, and adjusting the AD (apparent density) of initial developer can effectively reduce fluctuations in the bulk of the developer.

Such fluctuations in the bulk of the developer are thought to be caused by degradation in the surfaces of toner and carrier due to stress or fluctuations in the fluidity of the developer due to adherence of inorganic fine particles detached from the toner to the carrier. However, although the bulk of the developer may be increased by the above-described factors, such increase gradually slows down and then comes to an equilibrium. Therefore, holding the initial developer in such equilibrium can effectively suppress fluctuations in the bulk of the developer.

Based on the results of the experiment described below, according to this illustrative embodiment, the loose apparent density of the toner in the developer used in the developing device 4 is set to not greater than approximately 0.39 g/cm³.

If the loose apparent density of the toner is greater than 0.39 g/cm³, the bulk of the developer becomes relatively low at the initial state, so that degradation in the developer and/or spending of inorganic fine particles may result in a greater increase in the bulk of the developer. To reduce the loose apparent density of the toner, the amount of inorganic fine particles such as small-particle-diameter silica particles may be reduced, or the amount of wax on the surface of the toner may be increased.

In this regard, the loose apparent density is a density of toner at a state in which the toner is sifted with a sleeve, and indicates the fluidity of the toner. For the toner according to this illustrative embodiment, 10 g of the toner was put into a 50 ml graduated cylinder, a lid was put on the cylinder, and the cylinder was shaken 50 times. After the lid was opened, the cylinder was left for about 10 minutes, and the graduation of the cylinder was read. The ratio of the graduation to a measured amount of the toner was recorded as a measurement value of the loose apparent density. It is to be noted that the loose apparent density is not limited to the value measured by the above-described condition, but may be a value measured according to a principle similar to that of the above-described measuring method.

Based on the results of the experiment described below, for the toner of the developer used in the developing device 4 according to this illustrative embodiment, the coverage of external additives adhered to a toner base of the toner is set not greater than approximately 80% of the surface area of the toner base.

If the coverage of the external additive is greater than 80% of the surface area of the toner base, the amount of external additive detached from the toner base may notably increase. As a result, such detached external additive may increasingly adhere to the carrier or other material, resulting in a greater increase in the bulk of the developer. In this illustrative embodiment, the coverage of the external additive is expressed by a ratio of a value obtained by multiplying a surface area of the toner per gram by a weight percent of the toner to a value obtained by multiplying a projected area of the external additive per gram by a weight percent of the external additive.

Based on the results of the experiment described below, the developing device 4 according to this illustrative embodiment employs a two-component developer with an initial AD of from 1.55 g/cm³ to 1.70 g/cm³. As described above, the AD of the two-component developer approaches equilibrium as it is used. Therefore, setting the initial AD of the developer to a range of from approximately 1.55 g/cm³ to approximately 1.70 g/cm³ can suppress fluctuations in the bulk of developer. If the AD is greater than 1.70 g/cm³, the bulk of the developer may notably increase, resulting in an increase in internal pressure and thus toner scattering from the device. If the AD is less than 1.55 g/cm³, a long-time unused state may decrease the bulk of the developer, resulting in image failures such as uneven image density.

In this regard, the AD was determined by the following manner.

Magnetic carrier and toner were weighed so that the weight of the developer becomes 200 gram and the concentration of the toner became 7 wt %. The magnetic carrier and the toner were put into a 500 ml bottle and agitated at 71 rpm for 25 minutes by a TURBULA shaker mixer. The developer thus prepared was measured in accordance with the “method for determining apparent density of metallic powder” defined in JIS Z2504.

In this illustrative embodiment, preferably the developer used in the developing device 4 includes a carrier with a weight-average particle diameter of 20 μm to 50 μm. If the average particle diameter of the carrier is less than 20 μm, the bulk of the developer may further increase, resulting in toner scattering from the device. Alternatively, if the average particle diameter of the carrier is greater than 50 μm, it may be difficult to meet the above-described condition for the AD.

In this illustrative embodiment, it is preferable that the content of inorganic fine particles with an average primary particle diameter of not less than 100 nm is not greater than 1.0 weight part per 100 weight parts of the toner base. The greater the average primary particle diameter, the inorganic fine particles become more easily detached from the toner even when the coverage of inorganic fine particles is low. In such case, although the detached inorganic fine particles adhere less to the carrier, the inorganic fine particles are present in the developer in the detached state, resulting in an increase in the bulk of the developer.

Next, an illustrative embodiment according to the present invention is described below. It is to be noted that the invention is not limited to the illustrative embodiment described above, and hereinafter, the term “part” represents “weight part” unless specifically noted otherwise.

When evaluating an image with a two-component developer, as described below, a ferrite carrier having an average particle diameter of 35 μm coated with silicon resin having an average thickness of 0.5 μm was used. The carrier and a toner were uniformly charged and mixed at a ratio of seven weight parts of each color toner per 100 weight parts of the carrier in a developer using a TURBULA mixer that rotates a container containing the toner and the carrier for agitation.

Example of Manufacture of Carrier

### Core Material:

5,000 parts of Mn ferrite particles (with a weight-average diameter of 35 μm)

### Coating materials:

450 parts of toluene

450 parts of silicon resin SR2400 (manufactured by Toray Dow-Corning Silicon Co., which contains 50% of non-volatile portion)

10 parts of Amino silane SH6020 (manufactured by Toray Dow-Corning Silicon Co.)

The coating materials were dispersed for 10 minutes using a stirrer to prepare a coating liquid, and this coating liquid and the core material were put into a coating apparatus, including a rotary bottom-plate disk and a stirrer vane in a fluid bed that coats while generating a spiral flow, so that the core material was coated by the coating liquid. The core material coated with the coated material was baked at 250° C. for two hours in an electric furnace to obtain the above-described carrier.

Example of Manufacture of Toner

### Synthesis of Organic Fine-Particle Emulsion

### MANUFACTURING EXAMPLE 1

In a reaction vessel equipped with a stirring rod and a thermometer, 683 parts of water, 11 parts of a sodium salt of sulfuric acid ester of ethylene oxide adduct of methacrylic acid (Eleminol RS-30, manufactured by Sanyo Chemical Industries, Ltd.), 166 parts of methacrylic acid, 110 parts of butyl acrylate, and one part of ammonium persulfate were stirred at 3800 rpm for 30 minutes to obtain a white emulsion. The emulsion was reacted at 75° C. for four hours, mixed with 30 parts of 1% aqueous solution of ammonium persulfate, and aged at 75° C. for 6 hours to obtain an aqueous dispersion (fine-particle dispersion 1) of a vinyl resin (copolymer of methacrylic acid-butyl acrylate-sodium salt of sulfuric acid ester of ethylene oxide adduct of methacrylic acid). The volume average particle diameter of the fine-particle dispersion 1 was 110 nm as measured with a particle size analyzer LA-920 (manufactured by Horiba Instruments Inc.). A portion of the fine-particle dispersion 1 was dried to isolate a resin component thereof. The Tg (glass transition temperature) of the resin component was 58° C., and the weight average molecular weight thereof was 130,000.

### Preparation of Aqueous Phase

### MANUFACTURING EXAMPLE 2

990 parts of water, 83 parts of fine-particle dispersion 1, 37 parts of 48.3% aqueous solution of sodium dodecyl diphenyl ether disulfonate (Eleminol MON-7, manufactured by Sanyo Chemical Industries, Ltd.), and 90 parts of ethyl acetate were mixed and stirred to obtain a milky-white liquid (hereinafter “aqueous phase 1”).

### Synthesis of Low-Molecular-Weight Polyester

### MANUFACTURING EXAMPLE 3

In a reaction vessel with a cooling tube, a stirrer, and a nitrogen inlet tube, 229 parts of bisphenol A ethylene oxide dimolar adduct, 529 parts of bisphenol A propylene oxide trimolar adduct, 208 parts of terephthalic acid, 46 parts of adipic acid, and two parts of dibutyltin oxide were placed and reacted at 230° C. for seven hours under normal pressure and then for five hours at reduced pressures of from 10 to 15 mmHg. Then, 44 parts of anhydrous trimellitic acid was introduced into the reaction vessel and reacted at 180° C. for three hours under normal pressure to obtain low-molecular-weight polyester 1. The low-molecular-weight polyester 1 had a number average molecular weight of 2,300, a weight average molecular weight of 670, a Tg of 43° C., and an acid value of 25.

### Synthesis of Intermediate Polyester

### MANUFACTURING EXAMPLE 4

In a reaction vessel equipped with a cooling tube, a stirrer, and a nitrogen inlet tube, 682 parts of bisphenol A ethylene oxide dimolar adduct, 81 parts of bisphenol A propylene oxide dimolar adduct, 283 parts of terephthalic acid, 22 parts of anhydrous trimellitic acid, and two parts of dibutyltin oxide were reacted at 230° C. under normal pressure for seven hours, and then under reduced pressures of 10 mmHg to 15 mmHg for five hours to obtain “intermediate polyester 1.” The “intermediate polyester 1” had a number average molecular weight of 2,200, a weight average molecular weight of 9,700, a Tg of 54° C., an acid value of 0.5, and a hydroxyl value of 52.

Next, 410 parts of “intermediate polyester 1,” 89 parts of isohorone diisocyanate, and 500 parts of ethyl acetate were placed in a reaction vessel equipped with a cooling tube, a stirrer, and a nitrogen inlet tube, and reacted at 100° C. for five hours to obtain “prepolymer 1.” The weight percent of the prepolymer 1 relative to free isocyanate was 1.53%.

### Synthesis of Ketimine

### MANUFACTURING EXAMPLE 5

In a reaction vessel equipped with a stirring rod and a thermometer, 170 parts of isohorone diamine and 75 parts of methyl ethyl ketone were placed and reacted at 50° C. for four and a half hours to obtain “ketimine compound 1.” The amine value of the ketimine compound 1 was 417.

### Synthesis of Master Batch (MB)

### MANUFACTURING EXAMPLE 6

1,200 parts of water, 540 parts of carbon black (Printex 35, manufactured by Degussa Inc., having a DBP oil absorption of 42 ml/100 mg and a PH of 9.5), and 1,200 parts of polyester resin were mixed using Henschel mixer (manufactured by Mitsui mining Co., Ltd.) into a mixture. The mixture was kneaded with two rolls at 130° C. for one hour, extended with pressure, cooled, and fractured using a pulverizer to obtain “master batch 1”.

### Preparation of Oil Phase

### MANUFACTURING EXAMPLE 7

378 parts of low-molecular-weight polyester 1,100 parts of carnauba wax, and 947 parts of ethyl acetate were put in a vessel equipped with a stirring rod and a thermometer, heated to 80° C. with stirring, held at 80° C. for five hours, and cooled to 30° C. in one hour. Then, 500 parts of master batch 1 and 500 parts of ethyl acetate were put in the vessel and mixed for one hour to obtain “raw material solution 1.”

1,324 parts of raw material solution 1 were transferred to another vessel and the carbon black and wax were dispersed in three passes using a bead mill (ULTRA VISCO MILL manufactured by AIMEX Co., Ltd.) under conditions of a liquid transfer rate of 1 kg/hr, a disk peripheral velocity of 6 m/sec, and a loading of 80% by volume of 0.5 mm zirconia beads. Then, 1,324 parts of 65% solution of low molecular polyester 1 in ethyl acetate were added, dispersed in two passes using the bead mill under the aforementioned conditions to obtain “pigment-wax dispersion liquid 1”. The solid content of pigment-wax dispersion 1 was 50% (130° C., 30 minutes).

### Emulsification to Desolvation

### MANUFACTURING EXAMPLE 8

749 parts of pigment-wax dispersion 1, 115 parts of prepolymer 1, and 2.9 parts of ketimine compound 1 were put in a vessel and mixed at 5,000 rpm for two minutes using a TK homomixer (manufactured by Tokushu Kika Kogyo Co., Ltd.). Then, 1,200 parts of aqueous phase 1 were added to the vessel, and mixed at 13,000 rpm for 25 minutes using the homomixer to obtain “emulsified slurry 1”.

Emulsified slurry 1 was put in a vessel equipped with a stirrer and a thermometer, desolvated at 30° C. for eight hours, and aged at 45° C. for seven hours to obtain “dispersed slurry 1”.

### Washing to Drying

### MANUFACTURING EXAMPLE 9

After filtering 100 parts of emulsified slurry 1 under a reduced pressure, (1) 100 parts of ion exchange water were added to a filter cake and mixed at 12,000 rpm for 10 minutes using a TK homomixer, followed by filtration.

(2) 100 parts of 10% sodium hydroxide aqueous solution were added to the filter cake of (1) and mixed at 12,000 rpm for 30 minutes using the TK homomixer, followed by filtration under reduced pressure.

(3) 100 parts of 10% hydrochloric acid were added to the filter cake of (2) and mixed at 12,000 rpm for 10 minutes using the TK homomixer, followed by filtration.

(4) 300 parts of ion exchange water were added to the filter cake of (3), mixed at 12,000 rpm for 10 minutes using the TK homomixer, and filtered twice to obtain “filter cake 1”.

Filter cake 1 was dried at 45° C. for 48 hours using a circulation wind drier and sifted through a 75-μm mesh screen to obtain “toner base particles 1.”

Experiments

With the electrophotographic toners according to the following Examples 1 to 5 and Comparative examples 1 to 3, toner scattering, developer shortage, background fogging, and uneven density were evaluated under the following conditions.

The electrophotographic toners according to the examples 1 to 5 and the comparative examples 1 to 3 are described below.

### EXAMPLE 1

To 100 parts of toner base of the above-described toner base particles 1 were added 0.7 parts of silica particles having an average primary particle diameter of 10 nm, 1.0 part of silica particles having an average primary particle diameter of 120 nm, and 0.7 parts of titanium oxide particles having an average primary particle diameter of 15 nm. The external additives were mixed and stirred at 2,400 rpm for two minutes for one cycle using a super mixer to obtain an electrophotographic toner of Example 1.

### COMPARATIVE EXAMPLE 1

To 100 parts of toner base of the toner base particles 1 were added 0.9 parts of silica particles having an average primary particle diameter of 10 nm, 0.5 parts of silica particles having an average primary particle diameter of 120 nm, and 0.5 parts of titanium oxide particles having an average primary particle diameter of 15 nm. The external additives were mixed and stirred at 2,400 rpm for two minutes for one cycle using the super mixer to obtain an electrophotographic toner of Comparative example 1.

### COMPARATIVE EXAMPLE 2

To 100 parts of toner base of the toner base particles 1 were added 0.7 parts of silica particles having an average primary particle diameter of 10 nm, 3.0 parts of silica particles having an average primary particle diameter of 120 nm, and 0.7 parts of titanium oxide particles having an average primary particle diameter of 15 nm. The external additives were mixed and stirred at 2,400 rpm for two minutes for one cycle using the super mixer to obtain an electrophotographic toner of Comparative example 2.

### COMPARATIVE EXAMPLE 3

To 100 parts of toner base of the toner base particles 1 were added 0.2 parts of silica particles having an average primary particle diameter of 10 nm, 1.0 parts of silica particles having an average primary particle diameter of 120 nm, and 0.7 parts of titanium oxide particles having an average primary particle diameter of 15 nm. The external additives were mixed and stirred at 2,400 rpm for two minutes for one cycle using the super mixer to obtain an electrophotographic toner of Comparative example 3.

### EXAMPLE 2

To 100 parts of toner base of the toner base particles 1 were added 0.5 parts of silica particles having an average primary particle diameter of 10 nm, 1.0 parts of silica particles having an average primary particle diameter of 10 nm, and 0.7 parts of titanium oxide particles having an average primary particle diameter of 15 nm. The external additives were mixed and stirred at 2,400 rpm for two minutes for one cycle using the super mixer to obtain an electrophotographic toner of Example 2.

### EXAMPLE 3

To 100 parts of toner base of the toner base particles 1 were added 0.7 parts of silica particles having an average primary particle diameter of 15 nm, 1.0 parts of silica particles having an average primary particle diameter of 150 nm, and 0.7 parts of titanium oxide particles having an average primary particle diameter of 15 nm. The external additives were mixed and stirred at 2,400 rpm for two minutes for one cycle using the super mixer to obtain an electrophotographic toner of Example 3.

### EXAMPLE 4

In Manufacturing Example 8 in the above-described manufacturing process of the toner base particles 1, the mixing time after addition of the aqueous phase was changed from 25 minutes to 30 minutes. As the conditions other than the mixing time, the same conditions as those in the case of toner base particles 1 were used to obtain “toner base particles 2”. To 100 parts of toner base of the toner base particles 2 were added 0.7 parts of silica particles having an average primary particle diameter of 10 nm, 1.0 parts of silica particles having an average primary particle diameter of 120 nm, and 0.7 parts of titanium oxide particles having an average primary particle diameter of 15 nm. The external additives were mixed and stirred at 2,400 rpm for two minutes for one cycle using the super mixer to obtain an electrophotographic toner of Example 4.

### EXAMPLE 5

To 100 parts of toner base of the toner base particles 1 were added 0.7 parts of silica particles having an average primary particle diameter of 10 nm, 1.0 parts of silica particles having an average primary particle diameter of 120 nm and 0.7 parts of titanium oxide particles having an average primary particle diameter of 15 nm. The external additives were mixed and stirred at 2,400 rpm for two minutes for one cycle using the super mixer to obtain an electrophotographic toner of Example 5. As the carrier, a carrier to which 150,000 parts of amino silane SH6020 were added was used.

The physical characteristics of toners thus obtained are shown in Table 1 below.

TABLE 1

| | Inorganic Particles | | | | | | | | | |
|---|---|---|---|---|---|---|---|---|---|---|
| | Inorganic Particles 1 | | | Inorganic Particles 2 | | | Inorganic Particles 3 | | | |
| | | Primary | | | Primary | | | Primary | | |
| | Addition | Particle | | Addition | Particle | | Addition | Particle | | |
| | Amount | Diameter | Coverage | Amount | Diameter | Coverage | Amount | Diameter | Coverage | Coverage |
| | (Parts) | (nm) | (%) | (Parts) | (nm) | (%) | (Parts) | (nm) | (%) | (%) |
| Example 1 | 0.7 | 10.0 | 52.0 | 1.0 | 120.0 | 6.0 | 0.7 | 15.0 | 11.0 | 69.0 |
| Comparative | 0.9 | 10.0 | 67.0 | 0.5 | 120.0 | 3.0 | 0.5 | 15.0 | 8.0 | 78.0 |
| Example 1 | | | | | | | | | | |
| Comparative | 0.7 | 10.0 | 52.0 | 3.0 | 120.0 | 18.0 | 0.7 | 15.0 | 11.0 | 81.0 |
| Example 2 | | | | | | | | | | |
| Comparative | 0.2 | 10.0 | 14.5 | 1.0 | 120.0 | 6.0 | 0.7 | 15.0 | 11.0 | 17.0 |
| Example 3 | | | | | | | | | | |
| Example 2 | 0.5 | 10.0 | 50.0 | 1.0 | 120.0 | 8.0 | 0.7 | 15.0 | 15.0 | 73.0 |
| Example 3 | 0.7 | 15.0 | 35.0 | 1.0 | 150.0 | 5.0 | 0.7 | 15.0 | 11.0 | 51.0 |
| Example 4 | 0.7 | 10.0 | 52.0 | 1.0 | 120.0 | 6.0 | 0.7 | 15.0 | 11.0 | 69.0 |
| Example 5 | 0.7 | 10.0 | 52.0 | 1.0 | 120.0 | 6.0 | 0.7 | 15.0 | 11.0 | 69.0 |

Toner scattering, developer shortage, background fogging, and uneven density are described below.

Toner Scattering

With the image forming apparatus 500 according to this illustrative embodiment, a continuous output test was conducted in which a chart with an image area coverage of 10% was continuously output for 50,000 pages and toner scattering after the output test was visually evaluated.

In Table 2, the term “very good” indicates a state in which toner scattering was not visible; the term “good” indicates a state in which toner scattering was slightly visible but did not matter; the term “acceptable” indicates a state in which toner scattering was somewhat visible and close to a limit of the acceptable range; and the term “bad” indicates a state in which toner scattering was quite visible and out of the acceptable range.

Developer Shortage

With the image forming apparatus 500 according to this illustrative embodiment, a continuous output test was conducted in which a chart with an image area coverage of 10% was continuously output for 50,000 pages, and output images were observed to visually evaluate developer shortage. In Table 2, the term “good” indicates a state in which developer shortage was not visible on output images; the term “acceptable” indicates a state in which streaks were slightly visible at edge portions of the output images; and the term “bad” indicates a state in which streaks due to the pitch of the developing screw were clearly visible at edge portions of the output images.

Background Fogging

With the image forming apparatus 500 according to this illustrative embodiment, a continuous output test was conducted in which a chart with an image area coverage of 10% was continuously output for 50,000 pages. After stopping a white image during development, the developer remaining on a photoconductor after development was transferred onto a tape, and a difference in image density between the transferred tape and an un-transferred tape was measured by a 938 Spectrodensitometer (manufactured by X-Rite Inc.). In this evaluation, less difference in image density indicates less background fogging. The term “very good” indicates a ΔID of less than 0.005; the term “good” indicates a ΔID of from 0.005 to 0.01; the term “acceptable” indicates a ΔID of from 0.01 to 0.02; and the term “bad” indicates a ΔID of greater than 0.02.

Uneven Density

With the image forming apparatus 500 according to this illustrative embodiment, a continuous output test was conducted in which a chart with an image area coverage of 10% was continuously output for 50,000 pages, and output images were observed to visually evaluate uneven density. The term “good” indicates a state in which uneven density was not visible on output images; the term “acceptable” indicates a state in which uneven density was slightly visible; and the term “bad” indicates a state in which uneven density was visible over entire images.

The results of evaluation are shown in Table 2 below.

TABLE 2

| | Loose | Apparent | | | | |
|---|---|---|---|---|---|---|
| | Apparent | Density | | | | |
| | Density of | of | | | | |
| | Toner | Developer | Toner | Developer | Background | Uneven |
| | (g/cm³) | (g/cm³) | Scattering | Shortage | Fogging | Density |
| Example 1 | 0.35 | 1.63 | Very Good | Good | Good | Good |
| Comparative | 0.41 | 1.73 | Acceptable | Good | Bad | Acceptable |
| Example 1 | | | | | | |
| Comparative | 0.33 | 1.62 | Bad | Good | Acceptable | Good |
| Example 2 | | | | | | |
| Comparative | 0.28 | 1.51 | Acceptable | Bad | Acceptable | Acceptable |
| Example 3 | | | | | | |
| Example 2 | 0.36 | 1.61 | Good | Good | Good | Good |
| Example 3 | 0.34 | 1.60 | Very Good | Good | Good | Good |
| Example 4 | 0.38 | 1.68 | Good | Good | Good | Good |
| Example 5 | 0.35 | 1.56 | Good | Good | Good | Good |

Using a two-component developer in which the loose apparent density of toner is 0.39 g/cm³, the coverage of external additives adhered to a toner base is not greater than 80% of the surface area of the toner base, and the apparent density of the two-component developer including toner and magnetic carrier is in a range of from 1.55 g/cm³ to 1.70 g/cm³ as shown in Examples 1 to 5 can suppress fluctuations in the bulk of the developer over a relatively long period, prevent an increase in internal pressure of the developing device and toner scattering from the device, and provide a preferred image quality even when the particle diameters of the toner and the carrier are relatively small or the total amount of the developer is relatively large.

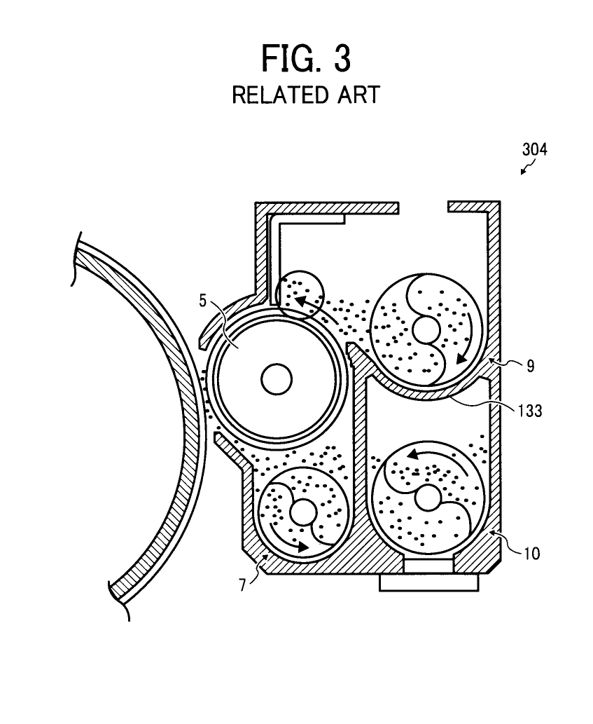

As with the conventional developing device 304 illustrated in FIG. 3, the above-described developing device 4 of the image forming apparatus 500 according to this illustrative embodiment has three developer transport paths including the supply transport path 9, the collection transport path 7, and the agitation transport path 10 that serves as a circulation transport path.

The developer used in this illustrative embodiment capable of suppressing fluctuations in the bulk of the developer is also applicable to a developing device such as the conventional developing device 204 illustrated in FIG. 2, having two developer transport paths including the supply transport path 9 and the collection transport path 7 that serves as a circulation transport path.

Using a developer in which the loose apparent density of toner is not greater than 0.39 g/cm³, the coverage of external additives adhered to a toner base is not greater than 80% of the surface area of the toner base, and the apparent density of two-component developer is in a range of from 1.55 g/cm³ to 1.70 g/cm³ in the developing device 204 having the two developer transport paths as illustrated in FIG. 2 can suppress fluctuations in the bulk of the developer for a relatively long period, prevent an increase in internal pressure of the developing device and toner scattering from the device, and background fogging, thereby maintaining a preferred image quality even when the particle diameters of the toner and the carrier are relatively small or the total amount of the developer is relatively large.

In the conventional developing device 204 illustrated in FIG. 2, a toner supply device supplies toner to the collection transport path 7.

Further, the conventional developing device 204 illustrated in FIG. 2 can save space in a horizontal direction compared to a developing device having three developer transport paths.

However, the conventional developing device 204 illustrated in FIG. 2 directly supplies the developer, which has been transported to the collection transport path 7, to the supply transport path 9. As a result, even when the concentration of toner is appropriately maintained by supply of the toner, the toner may not be sufficiently agitated, resulting in unevenness or reduction in the density of an image under development. Such failure may become more noticeable in a higher-print-coverage image, which may result in a reduction in the concentration of the toner in the collected developer.

By contrast, the developing device 304 illustrated in FIG. 3 or the developing device 4 used in the image forming apparatus 500 according to this illustrative embodiment does not directly supply the collected developer to the supply transport path 9 but agitates the collected developer in the agitation transport path 10 before supplying the collected developer to the supply transport path 9, thereby allowing the collected developer to be supplied in a sufficiently agitated state. Accordingly, such configuration can prevent unevenness or reduction in the density of an image under development, which may appear in the conventional developing device 204 illustrated in FIG. 2.

As described above, according to this illustrative embodiment, the developing device 4 includes the developing roller 5 serving as a developer bearing member that rotates while bearing the developer and supplies the toner to a latent image on the surface of the photoconductor 1 serving as a latent image bearing member at an area at which the developing roller 5 faces the photoconductor 1. The developing device 4 further includes the supply transport path 9 having the supply screw 8 serving as a supply transport member that transports the developer in the axial direction of the developing roller 5 and supplies the developer to the developing roller 5. The developing device 4 further includes the agitation transport path 10 serving as a circulation transport path. The agitation transport path 10 has the agitation screw 11 serving as a circulation transport member that transports the developer, which has reached the downstream end portion in the transport direction of the supply transport path 9, to the upstream end portion in the transport direction of the supply transport path 9. The supply transport path 9 and the agitation transport path 10 are partitioned from each other by the partition member 133 including the openings connecting the supply transport path 9 and the agitation transport path 10 at the end portions in the axial direction thereof. The supply transport path 9 is disposed above the agitation transport path 10. In the developing device 4 is used a two-component developer for developing an electrostatically charged image including magnetic carrier and toner containing at least inorganic fine particles as external additive. The loose apparent density of the toner is not greater than 0.39 g/cm³ the coverage of external additives adhered to a toner base is not greater than 80% of the surface area of the toner base, and the apparent density of the two-component developer including the toner and the magnetic carrier is in a range of from 1.55 to 1.70 g/cm³. Such configuration can suppress fluctuations in the bulk of the developer over a relatively long period, prevent an increase in internal pressure of the developing device and toner scattering from the device, and provide a preferable image quality even when the particle diameters of the toner and the carrier are relatively small or the total amount of the developer is relatively large.

Further, the weight-average particle diameter of the carrier in the developer is in a range of from 20 μm to 50 μm. Setting the weight-average particle diameter of the carrier not less than 20 μm can suppress an increase in the bulk of the developer, thereby preventing toner scattering from the device. Setting the weight-average particle diameter of the carrier not greater than 50 μm can meet the condition needed for AD.

Inorganic fine particles having a relatively large average primary particle diameter become more readily detached from toner particles even if the coverage of inorganic fine particles over a toner base is low. Accordingly, setting the content of inorganic fine particles having an average primary particle diameter of not less than 100 nm to not greater than 1.0 part per 100 parts of the toner base can reduce the amount of detached inorganic fine particles in the developer, thereby preventing an increase in the bulk of the developer.

The concentration of toner in the developer is set within a range of from 5 wt % to 9 wt %. Too high a concentration of toner may result in toner scattering or background fogging, while too low a concentration of toner may result in failures such as poor filling in of a solid area and noticeable adherence of carrier. Hence, setting the toner concentration within the range of from 5 wt % to 9 wt % can suppress such failures.

The developing device 4 further includes the collection transport path 7 having the collection screw 6 serving as a collection transport member. The collection screw 6 collects the developer remaining on the developing roller 5 after the developer passes through the area at which the developing roller 5 faces the photoconductor 1, and transports the collected developer in the axial direction of the developing roller 5 or the same direction as the developer transfer direction of the supply screw 8. The agitation transport path 10 serving as a circulation transport path receives excess developer, which has been transported to an extreme downstream side in the developer transport direction of the supply transport path 9 without being used for development, and collected developer, which has been transported to an extreme downstream side in the developer transport direction of the collection transport path 7, and transports the received developer to the upstream end portion in the developer transport direction of the supply transport path 9. The developing device 4 does not directly supply the collected developer to the supply transport path 9 but agitates the collected developer in the agitation transport path 10 before supplying the collected developer to the supply transport path 9. Such configuration allows the developer to be supplied to the supply transport path 9 in a sufficiently agitated state, thereby preventing unevenness or reduction in the density of an image under development, which may appear in the conventional developing device 204 illustrated in FIG. 2.

Alternatively, the above-described developer may be used in the conventional developing device 204 illustrated in FIG. 2 that collects developer, which remains on the developing roller 5 after the developer passes through the area at which the developing roller 5 faces the photoconductor 1, in the collection transport path 7 serving as the circulation transport path and transports the collected developer to the upstream end portion in the developer transport direction of the supply transport path along with the developer transported to the extreme downstream side in the transport direction of the supply transport path 9 without being used for development. Such configuration may suppress fluctuations in the bulk of the developer over a relatively long period, prevent an increase in internal pressure of the developing device and toner scattering from the device, and provide a preferable image quality even when the particle diameters of the toner and the carrier are relatively small or the total amount of the developer is relatively large. Further, the developing device 204 illustrated in FIG. 2 can save space in a horizontal direction compared to a developing device including three developer transport paths.

At least one of the openings provided at the end portions in the axial direction of the partition member 133 is provided within the width of the developer bearing member, i.e., the width of the developing roller 5 in the axial direction thereof. Such configuration allows the width of the upper portion of the developing device 4 including the supply transport path 9 and the developing roller 5 to be located within the width of the developing roller 5, thereby saving space in the developing device 4.

In the partition member 133, the opening 91, through which the developer is transferred from the downstream end portion in the transport direction of the agitation transport path 10 to the upstream end portion in the transport direction of the supply transport path 9, and the opening 92, through which the developer is transferred from the downstream end portion of the supply transport path 9 to the upstream end portion in the transport direction of the agitation transport path 10, are located within the width α of the developer area. Compared to the developing device 4 according to the comparative example illustrated in FIG. 7, such configuration can save more space in the upper portion of the developing device 4 and thus in the entire developing device 4.

The circulation transport member is configured as the screw-shaped agitation screw 11 having a spiral-shaped blade disposed parallel to the axial line of the developing roller 5, thereby allowing the developer to be efficiently transported to the agitation transport path 10.

According to the above-described illustrative embodiment, the image forming apparatus 500 includes at least the photoconductor 1 serving as a latent image bearing member, the charger serving as a charging unit that charges the surface of the photoconductor 1, the optical write unit 21 serving as a latent image forming unit that forms an electrostatic latent image on the photoconductor 1, and a developing unit that develops the electrostatic latent image into a toner image. Using the developing device 4 as the developing unit can suppress fluctuations in the bulk of the developer over a long period, prevent an increase in internal pressure of the developing device and toner scattering from the device, and provide a preferable image quality even when the particle diameters of the toner and the carrier are relatively small or the total amount of the developer is relatively large.

Further, the image forming apparatus 500 may include the process cartridge 18 in which at least the photoconductor 1 and the developing unit for developing a latent image on the photoconductor 1 are held as a single unit by a holder. In such a case, the process cartridge 18 is detachably mountable in the image forming apparatus 500. Using the developing device 4 according to the above-described illustrative embodiment as the developing unit can facilitate a replacement operation of the developing device.

Further, in the developing device 4, the supply transport path 9 and the agitation transport path 10 serving as the circulation transport path are partitioned by the partition member 133. The partition member 133 has the openings connecting the supply transport path 9 and the agitation transport path 10 at the end portions in the axial direction, and the supply transport path 9 is disposed above the agitation transport path 10. In a method of forming an image using the developing device 4, the loose apparent density is set not greater than 0.39 g/cm³, the coverage of external additives adhered to a toner base is set not greater than 80% of the surface area of the toner base, and the apparent density of the two-component developer including the toner and the magnetic carrier is set within the range of from 1.55 to 1.70 g/cm³. Such configuration can suppress fluctuations in the bulk of the developer over a relatively long period, prevent an increase in internal pressure of the developing device and toner scattering from the device, and provide a preferable image quality even when the particle diameters of the toner and the carrier are relatively small or the total amount of the developer is relatively large.

Illustrative embodiments being thus described, it should be apparent to one skilled in the art after reading this disclosure that the examples and embodiments may be varied in many ways. Such variations are not to be regarded as a departure from the spirit and scope of the present invention, and such modifications are not excluded from the scope of the following claims.

What is claimed is:

1. A two-component developer used in an image forming apparatus including a latent image bearing member and a developing device,
the developer comprising:
a magnetic carrier; and
a toner including a toner base and inorganic fine particles as an external additive,
a loose apparent density of the toner being not greater than 0.39 g/cm³,
a coverage of the external additive over the toner base of the toner being not greater than 80% of a surface area of the toner base,
an apparent density of the developer being in a range of from 1.55 g/cm³ to 1.70 g/cm³,
the developing device including:
a developer bearing member configured to rotate while bearing the developer and supply the toner to a latent image on the latent image bearing member at an area at which the developer bearing member faces the latent image bearing member;
a supply transport path including a supply transport member configured to transport the developer in a transport direction along an axial direction of the developer bearing member and supply the developer to the developer bearing member;
a circulation transport path including a circulation transport member configured to transport the developer, transported to a downstream end portion in the transport direction of the supply transport path, to an upstream end portion in the transport direction of the supply transport path, the supply transport path being disposed above the circulation transport path; and
a partition member configured to partition the supply transport path from the circulation transport path, the partition member including openings that connect the supply transport path and the circulation transport path at end portions in the axial direction of the developer bearing member.

2. The developer according to claim 1, wherein a weight average particle diameter of the magnetic carrier is in a range of from 20 μm to 50 μm.

3. The developer according to claim 1, wherein, out of the inorganic fine particles, a content of inorganic fine particles having an average primary particle diameter of not less than 100 nm is not greater than 1.0 weight part per 100 weight parts of the toner base.

4. The developer according to claim 1, wherein a concentration of the toner in the developer is in a range of from 5 wt % to 9 wt %.

5. A developing device used in an image forming apparatus including a latent image bearing member, the developing device employing a two-component developer including a magnetic carrier and a toner, the toner including a toner base and inorganic fine particles as an external additive,
the developing device comprising:
a developer bearing member configured to rotate while bearing the developer and supply the toner to a latent image on the latent image bearing member at an area at which the developer bearing member faces the latent image bearing member;
a supply transport path including a supply transport member configured to transport the developer in a transport direction along an axial direction of the developer bearing member and supply the developer to the developer bearing member;
a circulation transport path including a circulation transport member configured to transport the developer, transported to a downstream end portion in the transport direction of the supply transport path, to an upstream end portion in the transport direction of the supply transport path, the supply transport path being disposed above the circulation transport path; and
a partition member configured to partition the supply transport path from the circulation transport path, the partition member including openings that connect the supply transport path and the circulation transport path at end portions in the axial direction of the developer bearing member,
a loose apparent density of the toner being not greater than 0.39 g/cm³,
a coverage of the external additive over the toner base of the toner being not greater than 80% of a surface area of the toner base,
an apparent density of the developer being in a range of from 1.55 g/cm³ to 1.70 g/cm³.

6. The developing device according to claim 5, further comprising:
a collection transport path including a collection transport member configured to collect the developer on the developer bearing member after the developer passes through the area at which the developer bearing member faces the latent image bearing member, and transport the developer along the axial direction of the developer bearing member and in the same transport direction as the transport direction of the supply transport member,
wherein the circulation transport path receives supply of the developer transported to an extreme downstream side in the transport direction of the supply transport path without being used for development and the developer transported to an extreme downstream side in the transport direction of the collection transport path and transports the supplied developer to the upstream end portion in the transport direction of the supply transport path.

7. The developing device according to claim 5, wherein, after passing through the area, the developer on the developer bearing member is collected in the circulation transport path and transported to the upstream end portion in the transport direction of the supply transport path together with the developer transported to the extreme downstream side in the transport direction of the supply transport path without being used for development.

8. The developing device according to claim 5, wherein at least one opening of the openings at the end portions of the partition member in the axial direction of the developer bearing member is provided within a width in the axial direction of the developer bearing member.

9. The developing device according to claim 5, wherein at least one opening of the openings at the end portions of the partition member in the axial direction of the developer bearing member is provided within a width of a development area, to which the developer bearing member supplies the toner to the latent image bearing member, in the axial direction of the developer bearing member.

10. The developing device according to claim 5, wherein the circulation transport member is a screw-shaped member including a spiral-shaped blade disposed parallel to the axial direction of the developer bearing member.

11. A process cartridge detachably mountable in an image forming apparatus,
the process cartridge comprising:
a latent image bearing member configured to bear a latent image;
the developing device according to claim 5; and
a holder configured to hold at least the latent image bearing member and the developing device as a single unit.

12. An image forming apparatus comprising:
a latent image bearing member configured to bear a latent image;
a charging unit configured to charge the latent image bearing member;
a latent image forming unit configured to form the latent image on the latent image bearing member; and
a developing device configured to develop the latent image into a toner image using a two-component developer including a magnetic carrier and a toner, the toner including a toner base and inorganic fine particles as an external additive,
the developing device including:
a developer bearing member configured to rotate while bearing the developer and supply the toner to the latent image on the latent image bearing member at an area at which the developer bearing member faces the latent image bearing member;
a supply transport path including a supply transport member configured to transport the developer in a transport direction along an axial direction of the developer bearing member and supply the developer to the developer bearing member;
a circulation transport path including a circulation transport member configured to transport the developer, transported to a downstream end portion in the transport direction of the supply transport path, to an upstream end portion in the transport direction of the supply transport path, the supply transport path being disposed above the circulation transport path; and
a partition member configured to partition the supply transport path from the circulation transport path, the partition member including openings that connect the supply transport path and the circulation transport path at end portions in the axial direction of the developer bearing member,
a loose apparent density of the toner being not greater than 0.39 g/cm³,
a coverage of the external additive over the toner base of the toner being not greater than 80% of a surface area of the toner base,
an apparent density of the developer being in a range of from 1.55 g/cm³ to 1.70 g/cm³.
